(19) United States
(12) Patent Application Publication
(10) Pub. No.: US 2016/0027074 A1
(43) Pub. Date: Jan. 28, 2016

(54) DETERMINING CONTENT PRICES FROM JOURNALIST METADATA

(71) Applicant: Qbeats Inc., New York, NY (US)

(72) Inventor: Illan Poreh, Miami Beach, FL (US)

(73) Assignee: Qbeats Inc., New York, NY (US)

(21) Appl. No.: 14/809,080

(22) Filed: Jul. 24, 2015

Related U.S. Application Data
(60) Provisional application No. 62/028,681, filed on Jul. 24, 2014.

(51) Int. Cl. G06Q 30/02; G06Q 50/00; G06Q 30/06

(52) U.S. Cl. CPC G06Q 30/0283; G06Q 30/0641; G06Q 50/01; G06Q 30/0201

(57) ABSTRACT

Methods, systems, and apparatus, including computer programs encoded on computer storage media, for obtaining, from a content management system, a plurality of articles and respective information for each article in the plurality of articles; obtaining, for the journalist of each article, respective metadata of the journalist, wherein the respective metadata comprises at least an influence metric of the journalist; processing, for each article, the respective information and the respective metadata of the journalist of the article as training data to train a regression model; and providing a first article and metadata of an journalist of the first article as inputs to the regression model and determining, with the regression model, using one or more computers of the content management system, an initial price of the first article.

### RELATED CASES

This application claims benefit of U.S. Provisional Appl. No. 62/028,681, filed Jul. 24, 2014, which is incorporated herein by reference in its entirety.

### BACKGROUND

This specification relates to determining content prices from journalist metadata.

Publishers can charge prices for access to content created by journalists. The prices can be subscription-based. For example, users can pay a monthly fee to a particular publisher for access to content from the publisher. The prices can also be article-based. For example, users can pay a custom price to the publisher to access an individual piece of content, e.g., an article. The custom price can be predetermined by the publisher of the content.

### SUMMARY

In general, this specification describes a system for determining initial content prices, e.g., article prices, from journalist metadata. The system can, for each article published by a publisher system, determine a substantially optimal price for the article to increase revenue for the publisher system. Ideally, an optimal price would maximize revenue, although given variations in user behavior and uncertainties in information, this idealized situation would be unlikely to occur. The substantially optimal price can be determined by a regression model trained on properties of previously published articles and metadata of journalists who authored the previously published articles.

In general, one innovative aspect of the subject matter described in this specification can be embodied in methods that include the actions of obtaining, from a content management system, a plurality of articles and respective information for each article in the plurality of articles, wherein the respective information comprises at least a respective journalist who authored the article, a respective price of the article, a respective user purchasing metric for the journalist, and a respective user purchasing metric for topics covered by the article; obtaining, for the journalist of each article, respective metadata of the journalist, wherein the respective metadata comprises at least an influence metric of the journalist; processing, for each article, the respective information and the respective metadata of the journalist of the article as training data to train a regression model; and providing a first article and metadata of an journalist of the first article as inputs to the regression model and determining, with the regression model, using one or more computers of the content management system, an initial price of the first article.

Implementations can include one or more of the following features. Generating instructions configured to display, on a user device, a user interface for purchasing the article at the initial price; and sending the instructions to the user device. The influence metric is based on social media data comprising one or more of the following, a number of followers of a user account of the journalist on one or more social media platforms, and a number of likes, shares, tweets, and comments on the user account on the one or more social media platforms. The user purchasing metric for the journalist represents an average buying power of users that have purchased or subscribed to previously written articles by the journalist, and wherein the user purchasing metric for the topics covered by the article represents an average buying power of users that have subscribed to the topics covered by the article. The respective metadata of the journalist includes one or more of the following: one or more locations of the journalist, one or more events covered by the journalist, a brand metric of the journalist, and a number of years of experience, wherein the brand metric of the journalist represents a type of publication the journalist has worked for.

Another innovative aspect can include the actions of obtaining, from a content management system, a plurality of subscriptions and respective information for each subscription in the plurality of subscriptions, wherein the respective information comprises at least a respective journalist who authored articles published in the subscription, a respective price of the subscription, a respective user purchasing metric for the journalist, and a respective user purchasing metric for topics covered by the subscription; obtaining, for the journalist of each subscription, respective metadata of the journalist, wherein the respective metadata comprises at least an influence metric of the journalist; processing, for each subscription, the respective information and the respective metadata of the journalist of the article as training data to train a regression model; and providing metadata for a plurality of journalists as inputs to the regression model and determining, with the regression model, using one or more computers of the content management system, an initial subscription price for content produced by the plurality of journalists.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In particular, one embodiment may include all the following features in combination.

Particular embodiments of the subject matter described in this specification can be implemented so as to realize one or more of the following advantages. Pricing content, e.g., a journalistic article, can be difficult and time-consuming. The system automatically determines a substantially optimal price for content using a trained model. For example, historical data can generally show that content created by more experienced or reputable journalists is valued more than content created by a new journalist, and the model can incorporate the historical data to generate a substantially optimal price. Ideally, the optimal price allows the publisher system to maximize revenue obtained for user access to the article.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example architecture for a content management system.

FIG. 2 shows example training data for an initial pricing system.

FIG. 3 shows a first example architecture for an initial pricing system.

FIG. 4 shows a second example architecture for an initial pricing system.

FIG. 5 shows a third example architecture for an initial pricing system.

FIG. 6 is a flow diagram of an example method for determining an initial price for an article.

Like reference numbers and designations in the various drawings indicate like elements.

### DETAILED DESCRIPTION

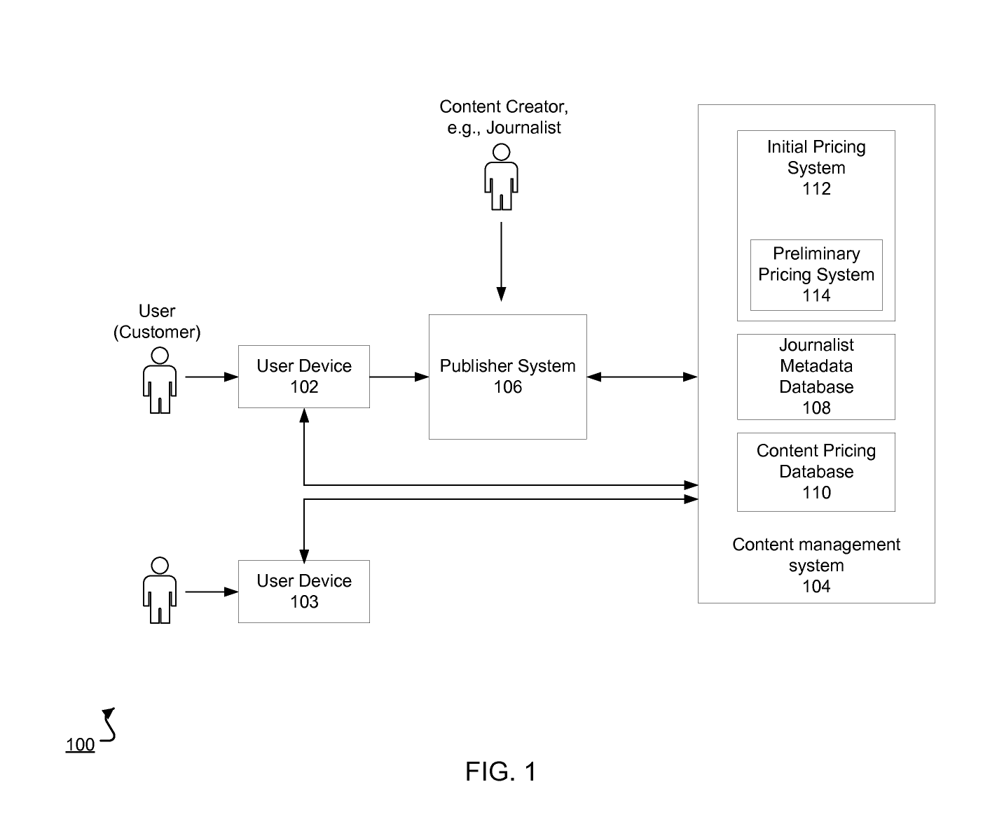

FIG. 1 shows an example architecture 100 for a content management system 104. The content management system 104 is an example of a system implemented as computer programs on one or more computers in one or more locations, in which the systems, components, and techniques described below are implemented.

The content management system 104 communicates with a publisher system 106. The publisher system 106 can include multiple servers in one or more locations. Each server can include memory, e.g., a random access memory (RAM), for storing instructions and data and a processor for executing stored instructions. The memory can include both read only and writable memory. Each server can be coupled to a database that stores resources.

The publisher system 106 can serve multiple resources to multiple users. In some implementations, a resource is a web page of content hosted by the publisher system 106. The resource can also be a media file, e.g., an audio or video file. The content of the resource can be created by journalists associated with the publisher system 106. For example, a content creator, e.g., a journalist, can upload the resource to the publisher system 106.

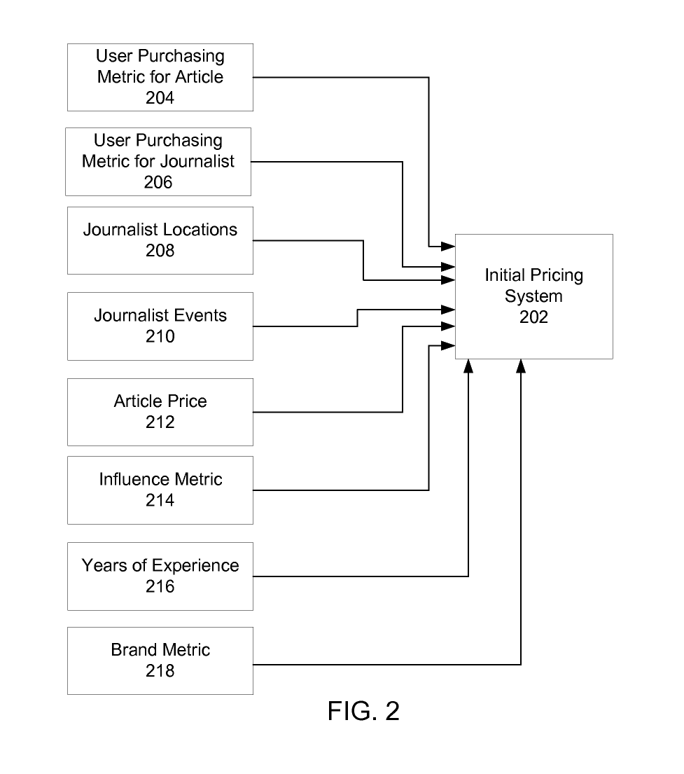

The content management system 104 can determine an initial content price for each resource of the publisher system 106 using an initial pricing system 112. To determine the initial content price, the initial pricing system 112 can first determine a preliminary content price for each resource using a preliminary pricing system 114. The preliminary content price can be based on the content of the resource and user demand of the resource, which will be described further below. The preliminary content price can be a factor in determining the initial content price. For example, the initial content price can be based on the preliminary content price, user purchasing metrics, and journalistic metadata, which can be obtained from a journalist metadata database 108. This will be described further below with reference to FIGS. 2-5. The initial content price for a resource can be a price for a user to access the resource, i.e., the initial content price is displayed to the user. In particular, the content management system 104 can determine the initial content price dynamically, i.e., on an ongoing and regularly updated basis. The preliminary pricing system 114 can determine the preliminary content price based on one or more of an opening price request for the resource as manually set by the publisher, the content of the resource, e.g., text, category, topic, and user demand for the resource.

The content management system 104 can analyze the content of the resource, e.g., text, to identify most common terms in the content of the resource. The most common terms can be compared to most common terms in other resources served by the publisher system 106. The preliminary content price can be based on content prices of other resources that have most common terms similar to the most common terms in the resource. The publisher system 106 can send historical data, e.g., content prices and the most common terms of other resources, to the content management system 104 for calculation of the preliminary content price.

The user demand could be measured by the number of interactions with the interactive elements described below, e.g., the number of clicks on the elements. User demand could also be measured by the number of searches for the resource or for terms related to the resource. The publisher system 106 can send data, e.g., an opening price request, the resource itself, resource metadata like topic and author, and/or a measure of user demand, to the content management system 104 for calculation of the preliminary content price.

In some implementations, the preliminary content price is determined by applying a weight to each signal, e.g., an opening price request from the publisher, a content of the resource, user demand for the resource, to generate a respective intermediate value. The preliminary pricing system 114 can generate a sum from the intermediate values, multiply the sum by the current value of the default curve, and use the result as an index to a pre-calculated database of content prices, where the database of content prices maps indices to content prices.

This application also incorporates by reference U.S. application Ser. No. 13/404,957 titled “Dynamic Pricing Of Access To Content Where Pricing Varies With User Behavior Over Time To Optimize Total Revenue And Users Are Matched To Specific Content Of Interest” and U.S. application Ser. No. 14/719,279 titled “Automated Determination of Initial Value for Automated Delivery of News Items.” The preliminary content prices can be stored in a content pricing database 110.

A user can request access to a resource of the publisher system 106 using a user device 102. The user device 102 can include a memory, e.g., a random access memory (RAM), for storing instructions and data and a processor for executing stored instructions. The memory can include both read only and writable memory. For example, the user device can be a computer coupled to the publisher system 106 through a data communication network, e.g., local area network (LAN) or wide area network (WAN), e.g., the Internet, or a combination of networks, any of which may include wireless links.

The user device 102 can be a smartphone, tablet, a desktop computer, or a laptop computer. The user device is capable of receiving user input, e.g., through a touchscreen display or a pointing device, e.g., a mouse or a keyboard.

The publisher system 106 can receive the request from the user device 102 for a particular resource and, in response, obtain a price, e.g., the initial price, for the particular resource from the content management system 104. In some implementations, the user device downloads instructions including content and price of the particular resource from the publisher system 106. The instructions executed at the user device can prevent the content from being displayed at the user device until the user device provides payment, either to the publisher system 106 or to the content management system 104, of the price for the particular resource.

In some implementations, the content management system 104 includes a default curve of pricing over time, which can be one input into the algorithm used to calculate the content price displayed to a user. This default curve is a preset curve (i.e., not a function of measured user demand for the resource). In general, the default curve monotonically decreases as a function of time. Thus, absent other effects, e.g., a sudden increase in user demand, the content price will decrease over time. In some implementations, the default curve drives the content price to zero after a certain period of time. By way of illustration, the content price displayed to the user can be a function of an initial price generated by the initial pricing system 112, the default curve, and user demand.

FIG. 2 shows example training data for a pricing system 202, which can provide the pricing system 112. The pricing system 202 can include a regression model trained on one or more known kernels using conventional learning techniques. The kernels can include a radius basis function (RBF) kernel or a spline kernel.

The training data can be on a per-article basis. That is, each training input to the price modeling system 202 revolves around an article and includes, at least, an article price 212 for an article. The training input can also include one or more of the following: an average user purchasing metric for the article and metadata for a journalist who authored the article.

A content management system, e.g., the content management system 104 of FIG. 1, can obtain the metadata for a given journalist from external sources, e.g., using Application Programmable Interfaces (APIs) and crawling public resources on the Internet. The content management system can also obtain the metadata from a publisher system, which can obtain the metadata from submission by the journalist.

The journalist metadata can include one or more of the following: an average user purchasing metric 206 for the journalist, an influence metric 214 of the journalist, one or more locations 208 of the journalist, one or more events 210 covered by the journalist, a brand metric 218 of the journalist, and a number of years of experience 216 of the journalist.

A user purchasing metric can represent a buying power of a user. In some implementations, the buying power of a particular user is based on a location of the user. To purchase articles from a publication, a particular user registers a user account at a content management system. The user account can be associated with a location of the user. The content management system can determine the location through user-submitted data or an Internet Protocol (IP) address of the user. Users located in affluent countries, e.g., the United States, can be attributed a higher buying power, i.e., user purchasing metric, than users located in less-affluent countries, e.g., Nigeria.

In some implementations, the buying power of a particular user is based on previous purchase history of the particular user. The content management system can store previous purchases made by each user account. If the particular user has spent money on previous content, the particular user can be attributed a higher purchasing power, i.e., user purchasing metric, than a user who has never spent money on previous content.

As a result, the average user purchasing metric for the article 204 represents an average buying power of users that have subscribed to topics covered by the article. Each article can be associated, e.g., tagged, with a set of topics. The topics can be established by a publisher system or determined through textual analysis by the content management system. Each user can have a user account at the content management system associated with one or more selected topics. When new articles having the one or more selected topics are published, the content management system can send a notification to the user of the user account. Therefore, for every new article, the content management system can identify users subscribed to topics covered by the article and can calculate an average user purchasing metric.

Similarly, the average user purchasing metric for the journalist 206 represents an average buying power of users that have purchased or subscribed to previously written articles by the journalist.

The influence metric 214 is a measure of how influential a journalist is. The content management system can determine the influence metric 214 from social media data. The social media data can include one or more of the following: a number of followers of the user account on one or more social media platforms, e.g., Facebook and Twitter, and social interaction data. The social interaction data can include a number of likes, shares, favorites, tweets, retweets, and comments on the user account received through the one or more social media platforms. Users having a higher number of followers and social interactions have a higher influence metric 214 than users having a low number of followers and social interactions.

The locations 208 of the journalist are locations at which the journalist has resided in or reports about. The locations 208 can be provided to the content management system by a publisher system. Alternatively or in addition, the content management system can extract the locations 208 from the content, e.g., from the dateline of an article. Alternatively or in addition, the publisher system can determine the locations 208 through geo-location, e.g., of an IP address or provided to the publisher system by the journalist. In some implementations, the initial pricing system 202 weights one or more locations more heavily. For example, journalists located in Dubai can presumably have better access to content related to oil, and therefore the system prices content from those journalists higher than journalists located in San Francisco that report on oil.

The events 210 covered by the journalist are events or topics typically covered by the journalist. The events 210 can be self-reported, e.g., the journalist or publisher can input the events into the publisher system, which transmits the data to the content management system. Alternatively, the events 210 can be extracted from content produced by the journalist. The content management system can identify, e.g., using conventional textual analysis and natural language processing techniques, primary topics or events described in the content. Examples of topics include science, entertainment, commodities, technology, law, politics, sports, etc., but more specialized topics are possible, e.g., oil. In some implementations, the initial pricing system 202 weights one or more predetermined topics more heavily, e.g., heavily weight topics related to prices of raw materials.

The brand metric 218 of the journalist is a measure of influence of publishers the journalist has produced content for. The content management system can determine the brand metric 218 from work history data of the journalist. The work history data can be received from the publisher system or crawled through public APIs, e.g., LinkedIn API. The content management system can associate one or more publishers with a higher brand metric 218 than other publishers. For example, a journalist who has produced content for the New York Times can have a higher brand metric than a journalist who has produced content for a personal blog.

The number of years of experience 216 of the journalist is how long the journalist has been producing content. The content management system can determine the number of years of experience 216 from a public API or from the publisher system.

During either training or run-time of the regression model, the content management system can assemble the journalist metadata and properties of the article into a vector. Some journalists can have less metadata than others, e.g., the content management system may be unable to identify a number of years of experience for a particular journalist. Therefore, a lack of metadata can also be represented in the vector to be provided to the initial pricing system 202, e.g., as a ‘0’ in a vector. In some implementations, during training, the vector includes at least an article price. In some implementations, during run-time, the vector does not include the article price and includes at least an influence metric.

By way of illustration, Table 1 is an example representation of training data for Article A created by a journalist having 10,000 followers on social media, located in Dubai, having worked for the New York Times, and focusing on oil articles. Table 2 is an example representation of training data for Article B created by another journalist having 2,000 followers, located in San Francisco, having a personal blog, and focusing on sports articles.

TABLE 1

| | |
|---|---|
| Article Price | $0.99 |
| Number of Followers for Journalist | 10,000 |
| Location - London | 0 |
| Location - San Francisco | 0 |
| Location - Dubai | 1 |
| Number of years of experience | 8 |
| Brand metric | 1.2 |
| Event - Oil | 1 |
| Event - Sports | 0 |

TABLE 2

| | |
|---|---|
| Article Price | $0.50 |
| Number of Followers for Journalist | 2,000 |
| London | 0 |
| San Francisco | 1 |
| Dubai | 0 |
| Number of years of experience | 8 |
| Brand metric | 0.7 |
| Oil | 0 |
| Sports | 1 |

The training vector for Article A can be [0.99, 10,000, 0, 0, 1, 8, 1.2, 1, 0] and the training vector for Article B can be [0.50, 2000, 0, 1, 0, 8, 0.7, 0, 1]. Although these training vectors have been described as having three locations and two events, training vectors provided to the initial pricing system 202 can have hundreds or thousands of locations and events. These and other vectors can train the regression model to output an initial price given only journalistic metadata as inputs.

In some implementations, the regression model is a support vector machine (SVM). The SVM can take as input a matrix of training data. The length of each training vector can be N elements large, and if the content management system collects M such vectors, the regression model can be trained on training data represented in an M×N matrix using one or more kernels, e.g., an RBF or spline kernel.

An RBF kernel can be defined as:

$$K ( x , {x}^{′} ) = exp ( - \frac{{‖ x - {x}^{′} ‖}^{2}}{2 {σ}^{2}} )$$

A spline kernel can be defined as:

$$K ( x , {x}^{′} ) = {\sum }_{r = 0}^{K} {x}^{r} {x}^{′ r} + {\sum }_{s = 1}^{N} {( x - {τ}_{s} )}_{+}^{K} {( {x}^{′} - {τ}_{s} )}_{+}^{K} .$$

The initial pricing system 202 can apply standard normalization procedure to each dimension of each vector. The initial pricing system 202 can compute a mean and variance of data in that dimension, scaling the data to values in the range from 0 to 1. Each dimension can be scaled to have the same variance across the vector. The means and variances used to perform the scaling are stored for each dimension before the vector trains the regression model.

Next, the initial pricing system 202 finds a parameter σ to achieve generalization. For example, the initial pricing system 202 can vary this parameter in context of k-fold cross validation.

The SVM can be formulated using a dual form of Lagrange multipliers and solved using quadratic programming or sequential minimal optimization methods.

During run-time, consider an example illustrated in Table 3 where the publisher system provided an article C and journalist metadata for article C.

TABLE 3

| Article Price | |
|---|---|
| Number of Followers for Journalist | 1,500 |
| London | 0 |
| San Francisco | 1 |
| Dubai | 0 |
| Number of years of experience | 3 |
| Brand metric | 1 |
| Oil | 1 |
| Sports | 1 |

Table 3 does not identify a price for the article, but identifies a journalist with the metadata that can be expressed by the vector [−, 1500, 0, 1, 0, 3, 1, 1, 1]. Without having processed this exact dataset before, i.e., the metadata is different from any previously inputted training data, the content management system can use the trained regression model described above to output an initial price for article C.

Although the regression model has been described with reference to determine initial prices for text articles, the regression model can be trained to generate prices for other content types, e.g., video or audio. In addition, although the regression model has been described with reference to determine initial prices for individual articles, the regression model can be trained to generate prices for subscriptions.

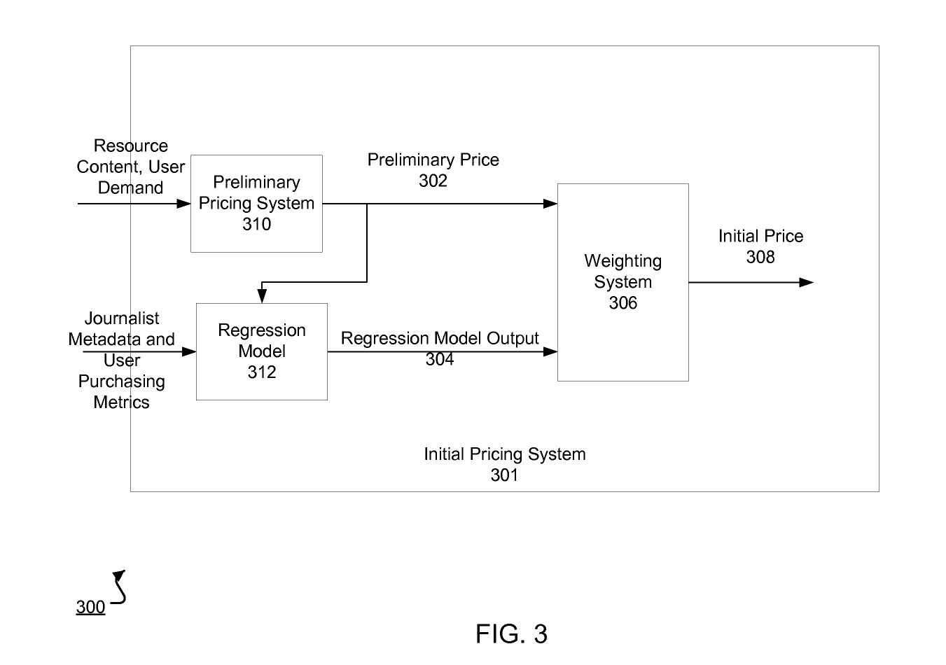

FIG. 3 shows a first example architecture 300 for an initial pricing system 301. In this architecture 300, a preliminary pricing system 310, e.g., the preliminary pricing system 114 of FIG. 1, is separate from a trained regression model 312. The preliminary pricing system 310 can determine a preliminary price 302 from resource content and user demand. The regression model 312 can be trained with the preliminary price 302 as described above with reference to FIG. 2. After training, the regression model 312 can generate an output 304, e.g., a price, from journalistic metadata and user purchasing metrics.

During run-time, the initial pricing system 301 can include a weighting system 306 that applies particular weights to the preliminary price 302 and the regression model output 304 to generate an initial price 308 to be stored in a content pricing database. The weights can be predetermined, e.g., the weighting system can weigh the regression model output 304 more than the preliminary price 302, or vice-versa. The weights can also be based on how much of a particular type of input data was processed by the initial pricing system 301. For example, for a particular piece of content, if there was not a significant amount of journalist metadata, the weighting system 306 can more heavily weight the preliminary price 302 instead of the regression model output 304.

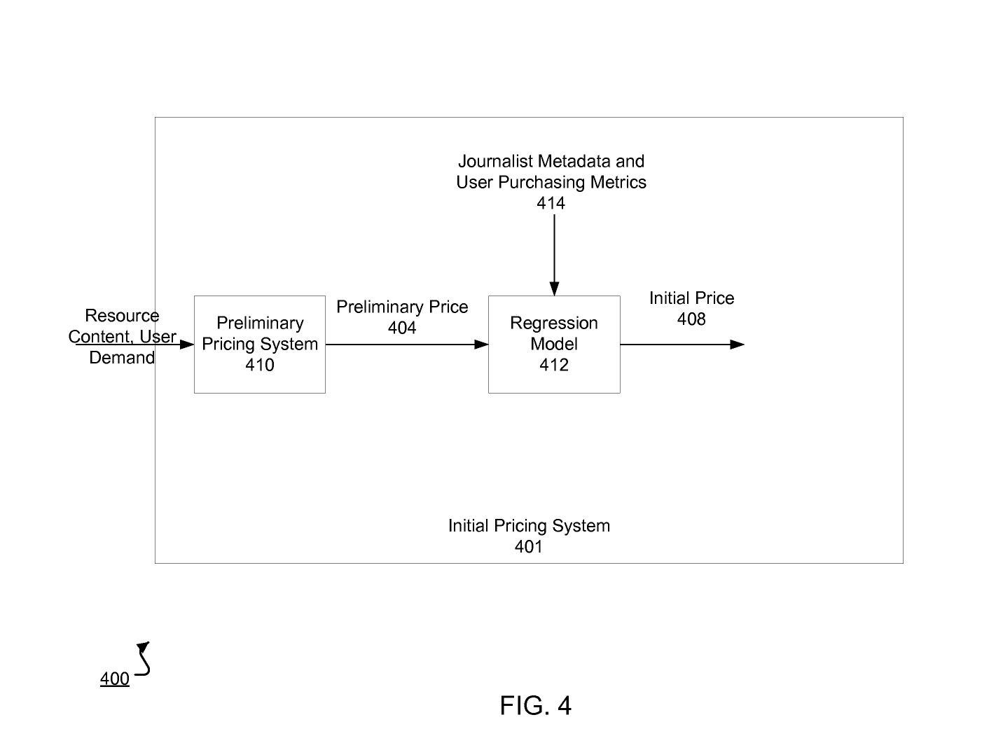

FIG. 4 shows a second example architecture 400 for an initial pricing system 401. A preliminary pricing system 410 can determine a preliminary price 404 for an article based on text of the article and user demand for the article. A regression model 412 can be trained on the determined preliminary price 404 of the article, journalist metadata, and user purchasing metrics 414.

During run-time, the regression model 412 can receive as inputs, for a new article, journalist metadata and user purchasing metrics to generate an initial price 408, as described above with reference to FIG. 2. In contrast to the architecture in FIG. 3, the initial price is determined from journalist metadata and user purchasing metrics 414 and not resource content and user demand.

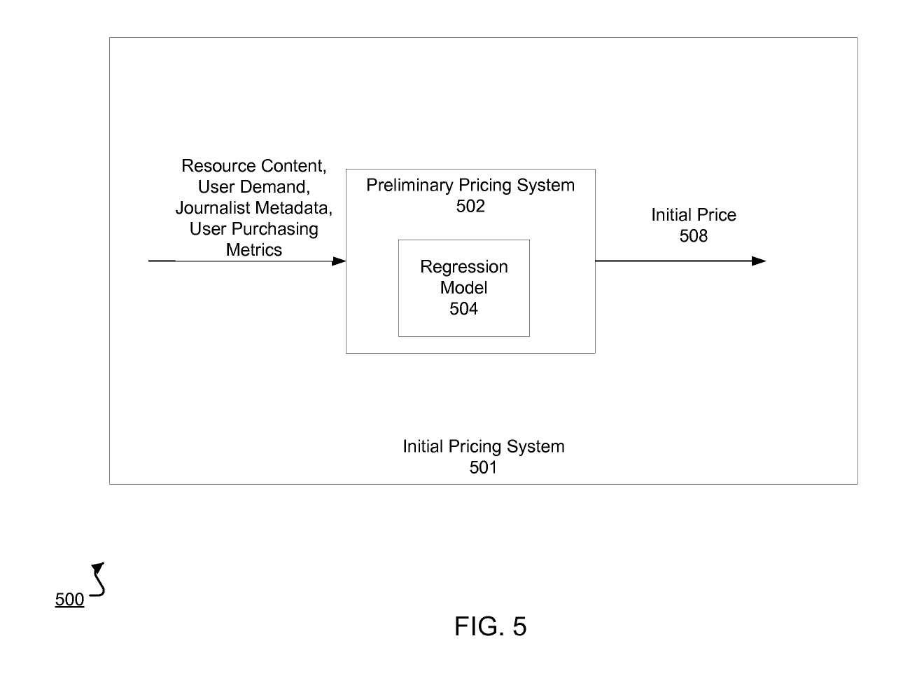

FIG. 5 shows a third example architecture 500 for an initial pricing system 501. In this architecture, a preliminary pricing system 502 can include a regression model 504. Instead of the regression model 504 being trained on only journalistic metadata and user purchasing metrics, the regression model 504 can be also trained on resource content and user demand. The training prices used to train the regression model 504 can be predetermined or generated by a preliminary pricing system processing only resource content and user demand as inputs, e.g., the preliminary pricing system 310 of FIG. 3.

The resource content and user demand can be converted into vector elements, e.g., numbers, that are appended to training or non-training vectors. For example, the vector can have an element corresponding to a particular keyword, and the element can be a number of occurrences of the particular keyword in the content. The vector can also have an element corresponding to user demand over time. For example, if a piece of content is being accessed 500 times per hour, a vector element representing user demand per hour can have a value of 500.

During run-time, the preliminary pricing system 502 can receive, for a piece of content, data specifying resource content, user demand, journalistic metadata, and user purchasing metrics to generate an initial price 508 for the content. That is, the preliminary pricing system 502 can convert the data into a vector of elements, provide the vector to the regression model 504, and output an initial price 508 for the content.

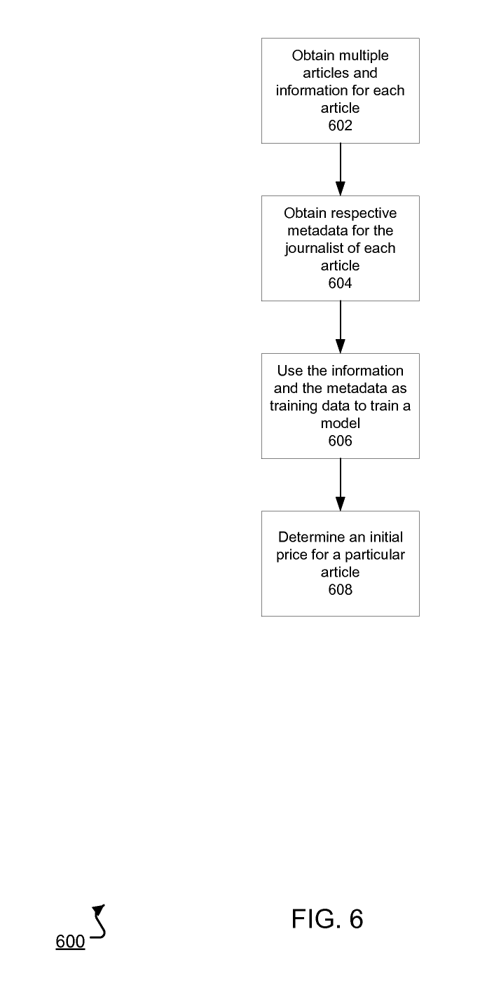

FIG. 6 is a flow diagram of an example method for determining an initial price for an article. For convenience, the method 600 will be described with respect to a system, e.g., the content management system 104 of FIG. 1, having one or more computing devices that execute software to implement the method 600.

The system obtains multiple articles and respective information, i.e., properties, for each article (step 602) from a publisher system, as described above with reference to FIG. 1.

The system obtains respective metadata for the journalist for each article (step 604). The system can either obtain the metadata from the publisher system or can crawl public resources for the metadata, as described above with reference to FIGS. 1 and 2.

The system uses the respective metadata and the respective information as training data to train a regression model (step 606) as described above with reference to FIG. 2.

The system determines an initial price for a particular article (step 608). The particular article can be newly created by a journalist. The system identifies metadata for the journalist, e.g., from a journalist metadata database, and provides the metadata to the trained regression model. The trained regression model can output an initial price, and the system can store the initial price in a content pricing database.

A user can use a user device to request user access to the newly created article for the established price. Upon receiving the request, the system can retrieve a payment account of the user. The payment account can be created, e.g., using Paypal, when the user registered at the system. The system can submit a transaction for the price to be processed at a payment processor using the payment account of the user. The system can receive authorization of the transaction and can send the authorization to the user device. After the system receives the payment authorization, the system can provide access to the newly created article, e.g., the system can send the article to the user device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To send for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can send input to the computer. Other kinds of devices can be used to send for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method, comprising:
obtaining, from a content management system, a plurality of articles and respective information for each article in the plurality of articles, wherein the respective information comprises at least a respective journalist who authored the article, a respective price of the article, a respective user purchasing metric for the journalist, and a respective user purchasing metric for topics covered by the article;
obtaining, for the journalist of each article, respective metadata of the journalist, wherein the respective metadata comprises at least an influence metric of the journalist;
processing, for each article, the respective information and the respective metadata of the journalist of the article as training data to train a regression model; and
providing a first article and metadata of an journalist of the first article as inputs to the regression model and determining, with the regression model, using one or more computers of the content management system, an initial price of the first article.

2. The method of claim 1, further comprising:
generating instructions configured to display, on a user device, a user interface for purchasing the article at the initial price; and
sending the instructions to the user device.

3. The method of claim 1, wherein the influence metric is based on social media data comprising one or more of the following, a number of followers of a user account of the journalist on one or more social media platforms, and a number of likes, shares, tweets, and comments on the user account on the one or more social media platforms.

4. The method of claim 1, wherein the user purchasing metric for the journalist represents an average buying power of users that have purchased or subscribed to previously written articles by the journalist, and wherein the user purchasing metric for the topics covered by the article represents an average buying power of users that have subscribed to the topics covered by the article.

5. The method of claim 1, wherein the respective metadata of the journalist includes one or more of the following: one or more locations of the journalist, one or more events covered by the journalist, a brand metric of the journalist, and a number of years of experience, wherein the brand metric of the journalist represents a type of publication the journalist has worked for.

6. A method, comprising:
obtaining, from a content management system, a plurality of subscriptions and respective information for each subscription in the plurality of subscriptions, wherein the respective information comprises at least a respective journalist who authored articles published in the subscription, a respective price of the subscription, a respective user purchasing metric for the journalist, and a respective user purchasing metric for topics covered by the subscription;
obtaining, for the journalist of each subscription, respective metadata of the journalist, wherein the respective metadata comprises at least an influence metric of the journalist;
processing, for each subscription, the respective information and the respective metadata of the journalist of the article as training data to train a regression model; and
providing metadata for a plurality of journalists as inputs to the regression model and determining, with the regression model, using one or more computers of the content management system, an initial subscription price for content produced by the plurality of journalists.

7. A system comprising:
one or more computers; and
computer-readable medium coupled to the one or more computers and having instructions stored thereon, which, when executed by the one or more computers, cause the one or more computers to perform operations comprising:
obtaining, from a content management system, a plurality of articles and respective information for each article in the plurality of articles, wherein the respective information comprises at least a respective journalist who authored the article, a respective price of the article, a respective user purchasing metric for the journalist, and a respective user purchasing metric for topics covered by the article;
obtaining, for the journalist of each article, respective metadata of the journalist, wherein the respective metadata comprises at least an influence metric of the journalist;
processing, for each article, the respective information and the respective metadata of the journalist of the article as training data to train a regression model; and
providing a first article and metadata of an journalist of the first article as inputs to the regression model and determining, with the regression model, using one or more computers of the content management system, an initial price of the first article.

8. The system of claim 7, further comprising:
generating instructions configured to display, on a user device, a user interface for purchasing the article at the initial price; and
sending the instructions to the user device.

9. The system of claim 7, wherein the influence metric is based on social media data comprising one or more of the following, a number of followers of a user account of the journalist on one or more social media platforms, and a number of likes, shares, tweets, and comments on the user account on the one or more social media platforms.

10. The system of claim 7, wherein the user purchasing metric for the journalist represents an average buying power of users that have purchased or subscribed to previously written articles by the journalist, and wherein the user purchasing metric for the topics covered by the article represents an average buying power of users that have subscribed to the topics covered by the article.

11. The system of claim 7, wherein the respective metadata of the journalist includes one or more of the following: one or more locations of the journalist, one or more events covered by the journalist, a brand metric of the journalist, and a number of years of experience, wherein the brand metric of the journalist represents a type of publication the journalist has worked for.

12. A computer-readable medium having instructions stored thereon, which, when executed by a processor, cause the processor to perform operations comprising:
obtaining, from a content management system, a plurality of articles and respective information for each article in the plurality of articles, wherein the respective information comprises at least a respective journalist who authored the article, a respective price of the article, a respective user purchasing metric for the journalist, and a respective user purchasing metric for topics covered by the article;
obtaining, for the journalist of each article, respective metadata of the journalist, wherein the respective metadata comprises at least an influence metric of the journalist;
processing, for each article, the respective information and the respective metadata of the journalist of the article as training data to train a regression model; and
providing a first article and metadata of an journalist of the first article as inputs to the regression model and determining, with the regression model, using one or more computers of the content management system, an initial price of the first article.

13. The computer-readable medium of claim 12, further comprising:
generating instructions configured to display, on a user device, a user interface for purchasing the article at the initial price; and
sending the instructions to the user device.

14. The computer-readable medium of claim 12, wherein the influence metric is based on social media data comprising one or more of the following, a number of followers of a user account of the journalist on one or more social media platforms, and a number of likes, shares, tweets, and comments on the user account on the one or more social media platforms.

15. The computer-readable medium of claim 12, wherein the user purchasing metric for the journalist represents an average buying power of users that have purchased or subscribed to previously written articles by the journalist, and wherein the user purchasing metric for the topics covered by the article represents an average buying power of users that have subscribed to the topics covered by the article.

16. The computer-readable medium of claim 12, wherein the respective metadata of the journalist includes one or more of the following: one or more locations of the journalist, one or more events covered by the journalist, a brand metric of the journalist, and a number of years of experience, wherein the brand metric of the journalist represents a type of publication the journalist has worked for.
